(19) United States
(12) Patent Application Publication
(10) Pub. No.: US 2020/0330318 A1
(43) Pub. Date: Oct. 22, 2020

(54) MASSAGE DEVICE

(71) Applicant: Hui-Ping Chou, Tainan (TW)

(72) Inventor: Hui-Ping Chou, Tainan (TW)

(73) Assignee: HORNG SHENG LIH ENTERPRISE CO., LTD., Tainan (TW)

(21) Appl. No.: 16/386,269

(22) Filed: Apr. 17, 2019

(51) Int. Cl. A61H 15/00; A61H 37/00; A47B 81/00

(52) U.S. Cl. CPC A61H 15/0092; A61H 2015/0021; A47B 81/007; A61H 37/00

(57) ABSTRACT

A massage device generally includes a massage stick, an accessory kit, and a rack. The massage stick includes a rod, two handle tubes, two massage tubes, eight bearings, two first sleeves, two second sleeves, three separation rings, and two nuts. The accessory kit includes two massage cylinders and a plurality of bushings including at least one double-taper bushing and at least two single-taper bushings, so that the massage stick can be detachably mounted with the massage cylinders through the bushings. The rack includes two lateral supports each defining a plurality of recesses positioned at different heights, so that the massage stick can be installed horizontally on the rack. With the massage stick, the rack, and the accessory kit, the massage device can be operated in various ways.

### BACKGROUND OF THE INVENTION

### Field of the Invention

The present invention relates to a massage device and, more particularly, to a massage device including a massage stick that can be detachably mounted with massage cylinders and installed on a rack, whereby the massage device can be operated in various ways.

### 2. DESCRIPTION OF THE PRIOR ART

There are two types of massage devices (devices with rolling parts; devices without rolling parts) commonly seen in the market. However, these devices can be operated in one way only. For a massage device with a rolling part, users may use the rolling part to massage a body part. For a massage device without a rolling part, users may use a fixed part thereof to rub or press a body part. To achieve various ways of massage, users need to purchase various massage devices, and this is inconvenient. To mitigate the disadvantage, there is a need to develop a massage device that can be operated in various ways.

### SUMMARY OF THE INVENTION

One object of the present invention to provide a massage device that can be operated in various ways.

The massage device generally comprises a massage stick, an accessory kit, and a rack. The massage stick includes a rod, two handle tubes, two massage tubes, eight bearings, two first sleeves, two second sleeves, three separation rings, and two nuts.

The two massage tubes are rotatably mounted between the handle tubes. The accessory kit includes two massage cylinders and a plurality of bushings including a double-taper bushing and two single-taper bushings, whereby the massage stick can be detachably mounted with the massage cylinders through the bushings. The rack includes two lateral supports each defining a plurality of recesses positioned at different heights, so that the massage stick can be installed horizontally on the rack.

More specifically, the handle tubes of the massage stick can be partly received in two recesses respectively defined at the two lateral supports, and fitted thereon with two retainers each snapped into two grooves of the corresponding recess.

More specifically, each of the handle tubes can be connected with a plug at one end that is distal from the massage tubes, and the plug can be used to conduct a massage.

More specifically, the double-taper bushing is configured to have two engagement surfaces, which respectively taper off towards two ends of the bushing. Each single-taper bushing is configured to have one engagement surface, which tapers off towards one end of the bushing. Furthermore, each of the bushings defines a groove along a full length thereof, and a slit opposite to the groove. Each of the massage cylinders is provided with a toothed portion at an inner surface thereof to facilitate gripping the bushings thereunder.

Other objects, advantages, and novel features of the present invention will become more apparent from the following detailed description when taken in conjunction with the accompanying drawings.

### BRIEF DESCRIPTION OF DRAWINGS

FIG. 1 shows an exploded view of a massage device according to one embodiment of the present invention.

FIG. 2 shows an assembled view of the massage device,

FIG. 3 shows an exploded view of a massage stick used in the massage device.

FIG. 4 shows a sectional view of the massage stick.

FIG. 5 shows an exploded view of the massage stick mounted with an accessory kit that includes two massage cylinders, two single-taper bushings, and one double-taper bushing.

FIG. 6 shows a sectional view of the massage stick mounted with the accessory kit shown in FIG. 5.

FIG. 7 shows an exploded view of the massage stick mounted with an accessory kit that includes two massage cylinders and four single-taper bushings.

FIG. 8 shows a sectional view of the massage stick mounted with the accessory kit shown in FIG. 7,

FIG. 9 shows a schematic operation view of the massage stick.

FIG. 10 shows a schematic operation view of the massage stick mounted with two massage cylinders.

FIG. 11 shows a schematic operation view of the massage stick mounted with two massage cylinders that are spaced apart at a greater distance.

FIG. 12 shows a schematic operation view of the massage device, wherein the massage stick mounted with two massage cylinders is installed on a rack,

FIG. 13 shows a schematic operation view of the massage device, wherein the massage stick mounted with two massage cylinders is installed on a rack, and the two massage cylinders are spaced apart at a greater distance.

### DETAILED DESCRIPTION OF THE PREFERRED EMBODIMENTS

To illustrate the effects and advantages of the present invention, a preferred embodiment is provided in the following paragraphs with reference to the accompanying drawings.

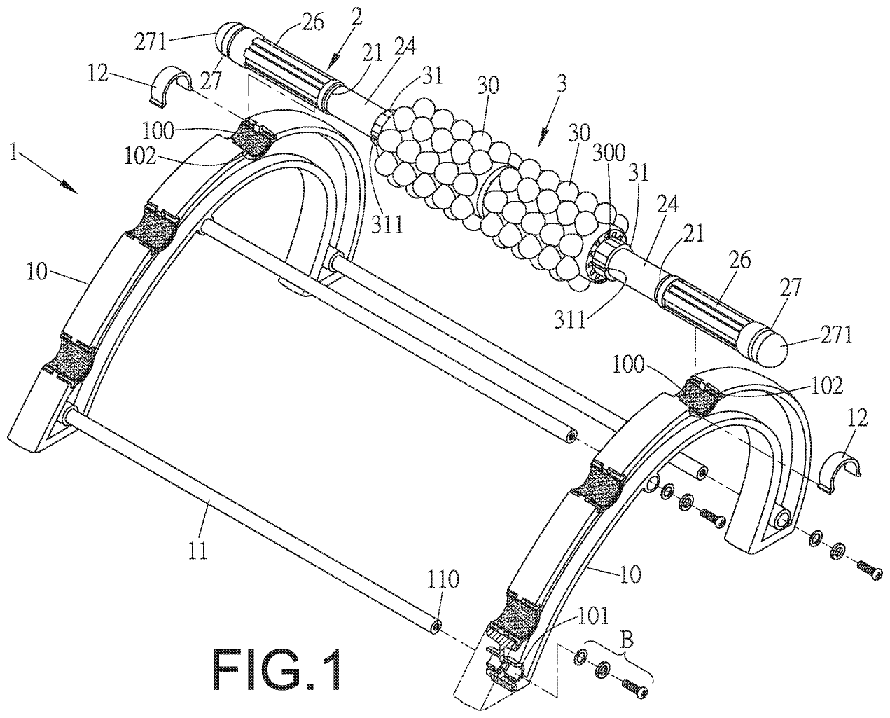

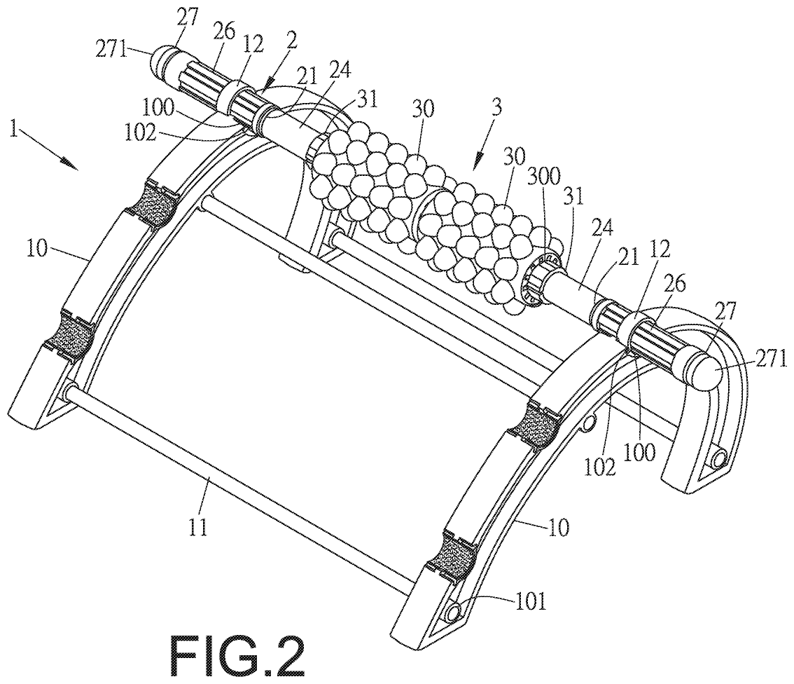

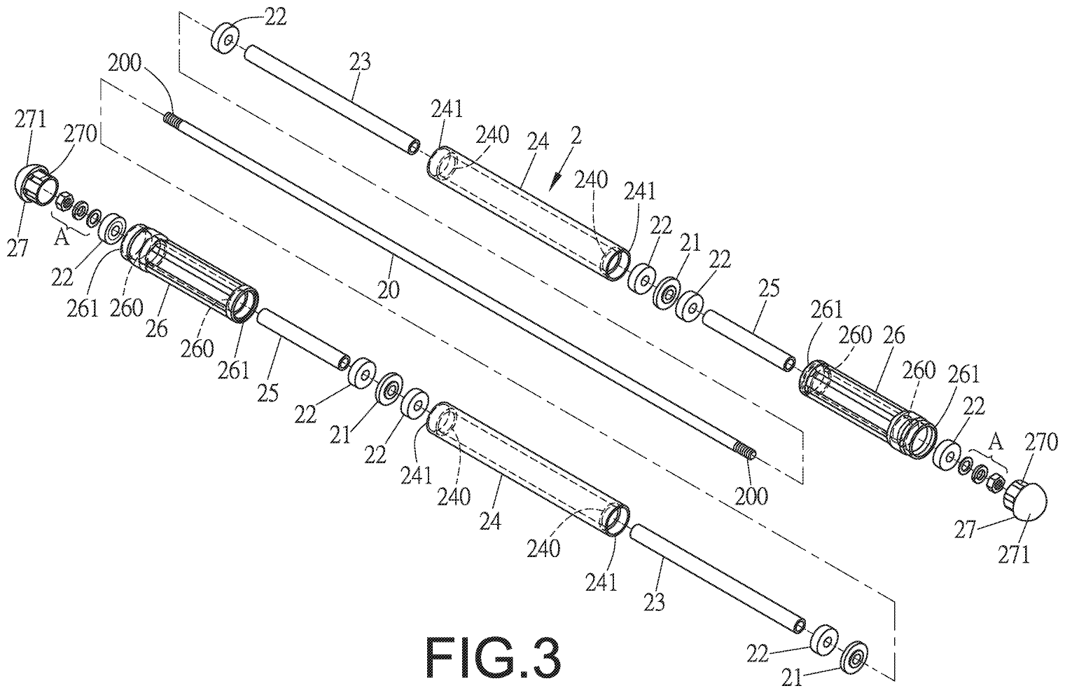

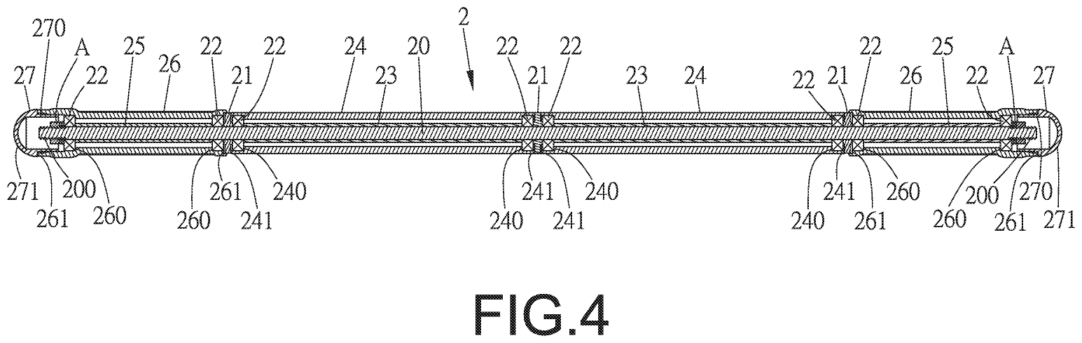

Referring to FIGS. 1 through 6, a massage device according to one embodiment of the present invention, generally includes a massage stick 2, a rack 1, and an accessory kit 3.

The massage stick 2 includes a rod 20, two handle tubes 26, two massage tubes 24, eight bearings 22, two first sleeves 25, two second sleeves 23, three separation rings 21, two nuts (A), and two plugs 27. The rod 20 has two threaded portions 200 formed at its two ends. The two handle tubes 26 are fitted around the rod 20 at locations respectively close to the two threaded portions 200, wherein each handle tube 26 is formed with two annular steps 260 at an inner surface thereof. The two massage tubes 24 are fitted around the rod 20 between the two handle tubes 26, wherein each massage tube 24 is formed with two annular steps 240 at an inner surface thereof. The eight bearings 22 are fitted around the rod 20 such that each of the handle tubes 26 and the massage tubes 24 contains therein two bearings 22, which abut the annular steps 260 formed therein. The two first sleeves 25 are fitted around the rod 20 such that each of the handle tubes 25 contains therein one sleeve located between two bearings 22 fitted therein. The two second sleeves 23 are fitted around the rod 20 such that each of the massage tubes 24 contains therein one sleeve located between two bearings 22 fitted therein. The three separation rings 21 are fitted around the rod 20, Each separation ring 21 is located between two adjacent tubes of the handle tubes 26 and the massage tubes 24, and abuts two bearings 22 respectively fitted in the adjacent tubes. The two nuts (A), together with washers, are connected with the two threaded portions 200 of the rod 20, so that the foregoing components can be assembled together, and the two handle tubes 26 and the massage tubes 24 can rotate about the rod 20 individually. The two plugs 27 each have their own heads 271 and connection portions 270 and can be connected to the ends 261 of the handle tubes 26 that are distal from the massage tubes 24. The heads 271 of the two plugs 27 can used to conduct a massage, such as rubbing or pressing the human body.

The rack 1 includes two arch-shaped lateral supports 10, each of which defines a plurality of recesses 100 positioned at different heights, wherein each recess 100 can be provided thereon with a pad. Also, each of the lateral supports 10 may define a plurality of through holes 101. A plurality of horizontal posts 11 can be connected between the two supports 10, wherein each of the posts 11 defines a threaded hole 110 at each end thereof and can be inserted into two corresponding through holes 101 at the lateral supports 10. A plurality of bolts (B), together with washers, can be screwed into the threaded holes 110 of the posts 11 so that the horizontal posts 11 can be connected between the two supports 10. Furthermore, the rack 1 can be provided with an anti-slip material at bottoms of the lateral supports 10. With the rack 1, the massage stick 2 can be placed across the two lateral supports 10 to have the handle tubes 26 thereof partly received in two recesses 100 respectively defined at the two lateral supports 10. Each of the retainers 12 is semicircular in shape and has two protrusions at its ends corresponding to two grooves 102 defined at each recess 100. The two retainers 12 can be fitted over the two handle tubes 26 respectively. The protrusions of each retainer 12 can be snapped into the grooves 102 of the corresponding recess, so that the massage stick can be installed horizontally on the rack 1.

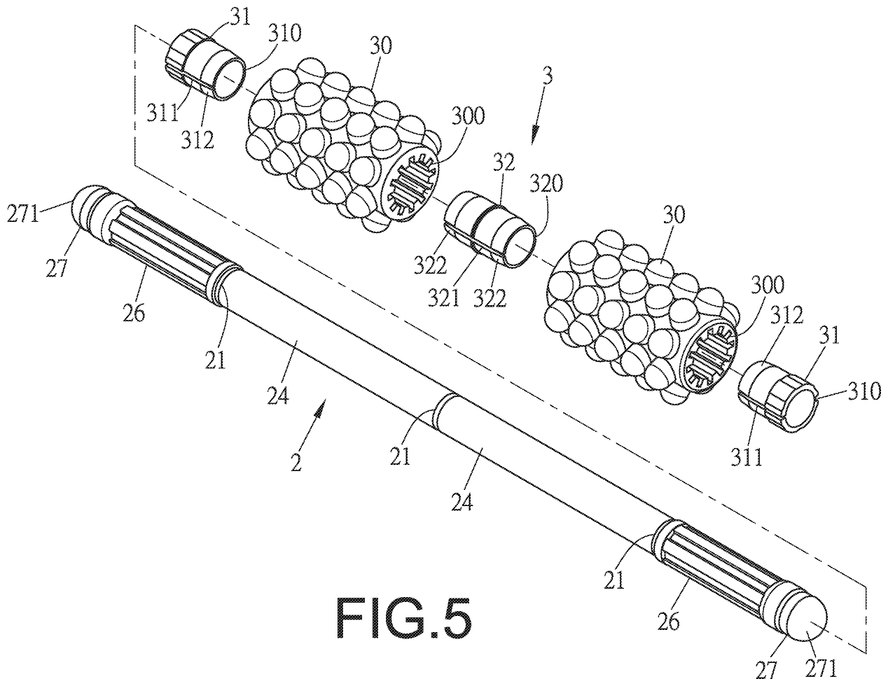

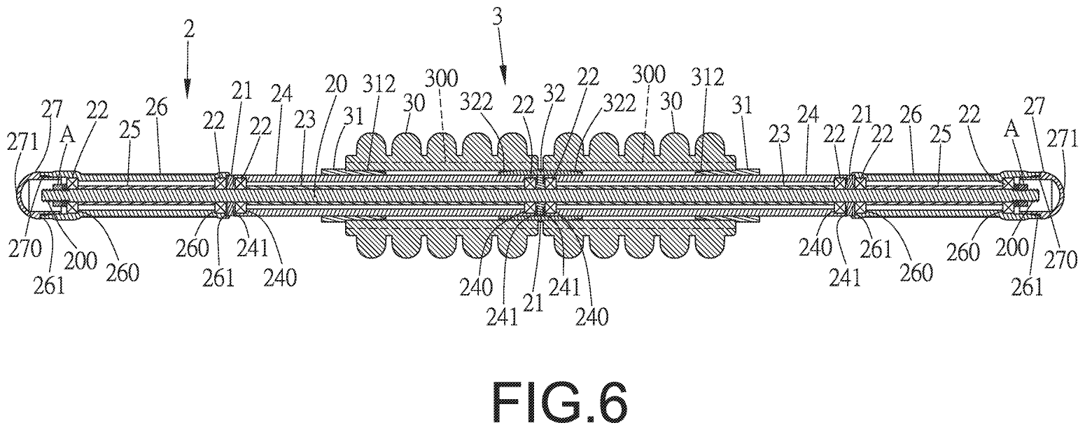

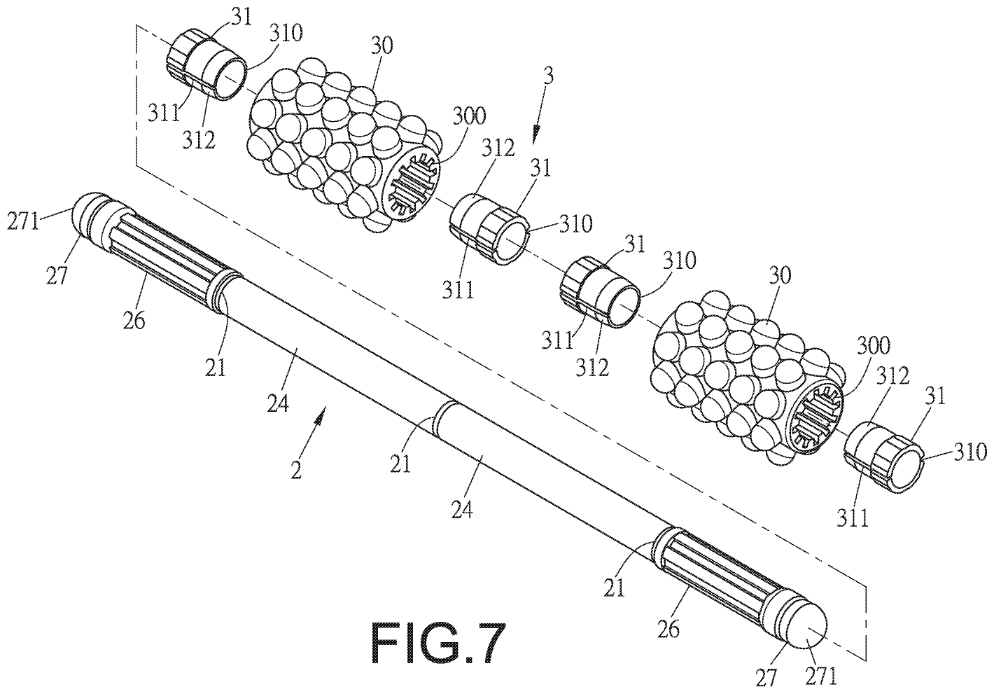

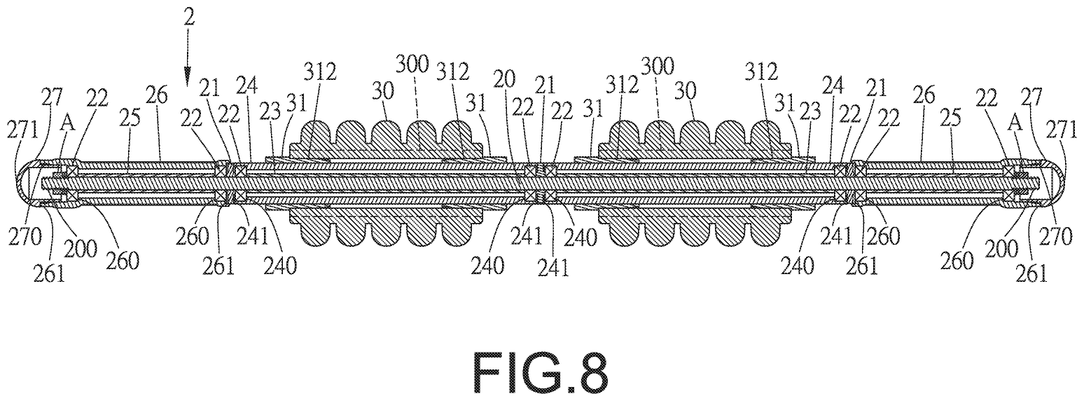

The accessory kit 3 may include two massage cylinders 30, two single-taper bushings 31, and a double-taper bushing 32. The massage cylinders 30, each of which has a number of bumps formed on its outer surface, and a toothed portion 300 formed at its inner surface, can be fitted around the two massage tubes 24 respectively. Each of the single-taper bushing 31 defines a groove 310 along a full length thereof and a slit 311 opposite to the groove 310, and is configured to have one engagement surface 312 tapering off towards one end of the busing. The double-taper bushing 32 defines a groove 320 along a full length thereof and a slit 321 opposite to the groove 320, and is configured to have two engagement surfaces 322 respectively tapering off towards two ends the bushing. Each of the single-taper bushings 31 can be fitted around one of the massage tubes 24 and inserted between the massage tube and the corresponding massage cylinder 30, so that the two massage cylinders 30 can be respectively fixed onto the two massage tubes 24 (see FIGS. 7 and 8). It is noticed that the toothed portion 300 can facilitate the massage cylinder 30 gripping the bushings thereunder, and the slit 311 of each single-taper bushing or the slit 321 of the double-taper bushing can be enlarged to allow the bushing to fit over one of the massage tubes 24. After the fitting operation, the slit 311 or 321 can return to its original size. Alternatively, the double-taper bushing 32 can be selected to fit around the two massage tubes 24, between which the central separation ring 21 is located, wherein the engagement surfaces 322 of the bushing 32 can be inserted between the massage cylinders 32 and the massage tubes 24 (see FIGS. 5 and 6). In such circumstances, the distance between the two massage cylinders 30 is relatively short compared with the case where the massage cylinders 30 are mounted by using the single-taper bushings only.

In assembling the massage stick 2, first of all, one separation ring 21 can be fitted around the rod 20 and located at a central location of the rod 20, and then two bearings 22 can be fitted around the rod 20 to respectively abut two sides of the central separation ring 21 and then two second sleeves 23 can be fitted around the rod 20 to respectively abut the two central bearings 22, Secondly, the two massage tubes 24 can be fitted around the rod 20 such that two annular steps 240 thereof respectively abut the two central bearings 22, and one end 241 of each massage tube 24 abuts the central separation ring 21. Thirdly, two bearings 22 can be fitted around the rod 20 to abut two annular steps 240 of the massage tubes 24 that are distal from the central separation ring 21 and to abut the second sleeves 23. Fourthly, two lateral separation rings 21 can be fitted around the rod 20 to abut another ends 241 of the two massage tubes 24 and the two bearings 22, which are distal from the central separation rings 21. Fifthly, two bearings 22 can be fitted around the rod 20 to abut the outer sides of the two lateral separation rings 21, and then two first sleeves 25 can be fitted around the rod 20 to abut the two bearings 22 located the outer sides of the two lateral separation rings 21. Sixthly, the two handle tubes 26 can be fitted around the rod 20 such that two annular steps 260 thereof abut the two bearings 22 located at the outer side of the two lateral separation rings 21, and the ends 261 thereof abut the two lateral separation rings 21. Seventhly, two bearings 22 can be fitted around the rod 20 to abut the annular steps 260 of the handle tubes 26 that are distal from the lateral separation rings 21 and to abut the first sleeves 25. Eighthly, two nuts (A) together with washers can be connected with the threaded portions 200 of the rod 20. Finally, two plugs 27 are connected to the two handle tubes 26 such that the connection portions 270 thereof can be inserted into the ends 261 of the handle tubes 26 that are distal from the massage tubes 24.

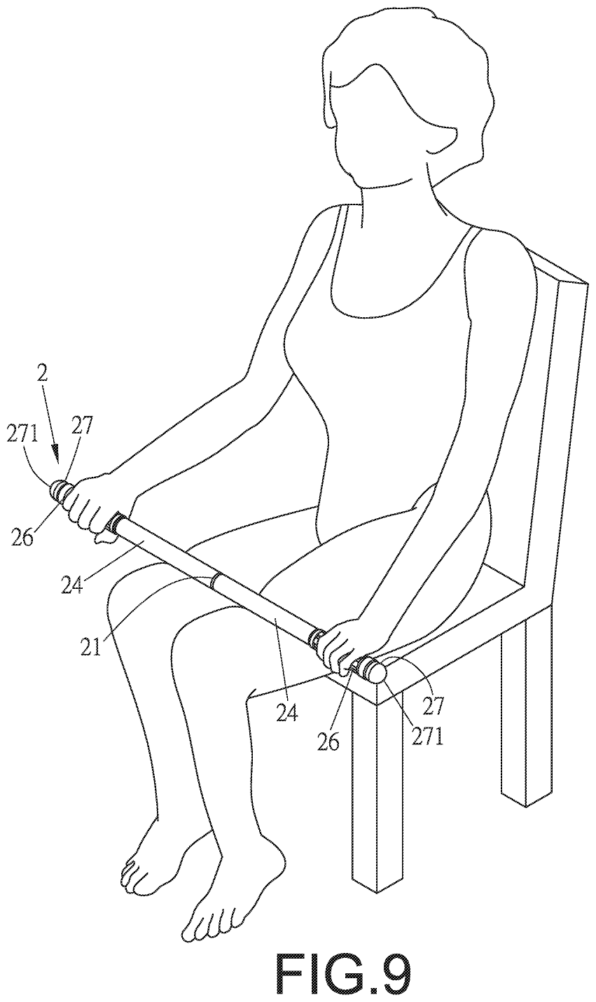

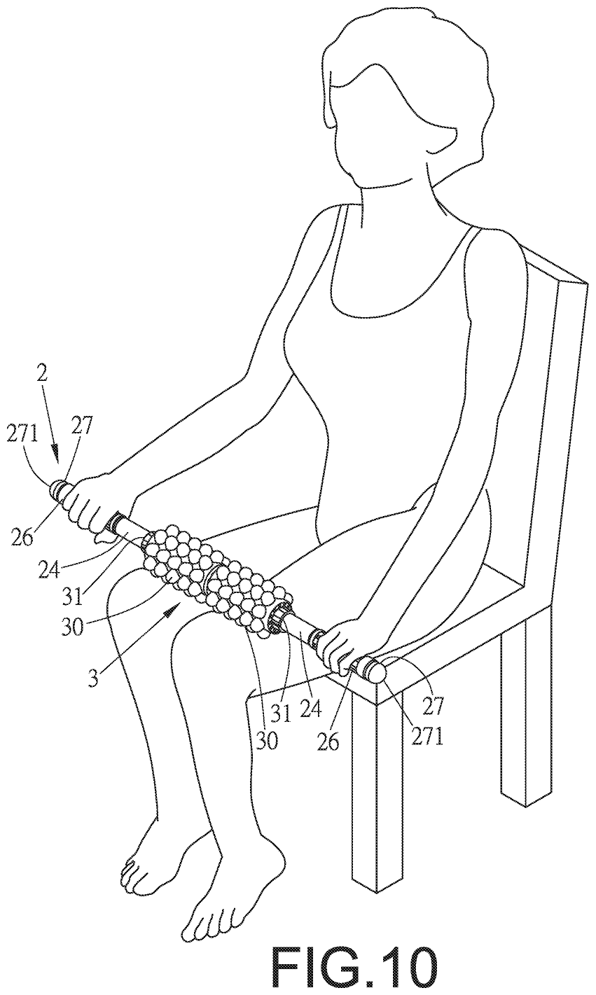

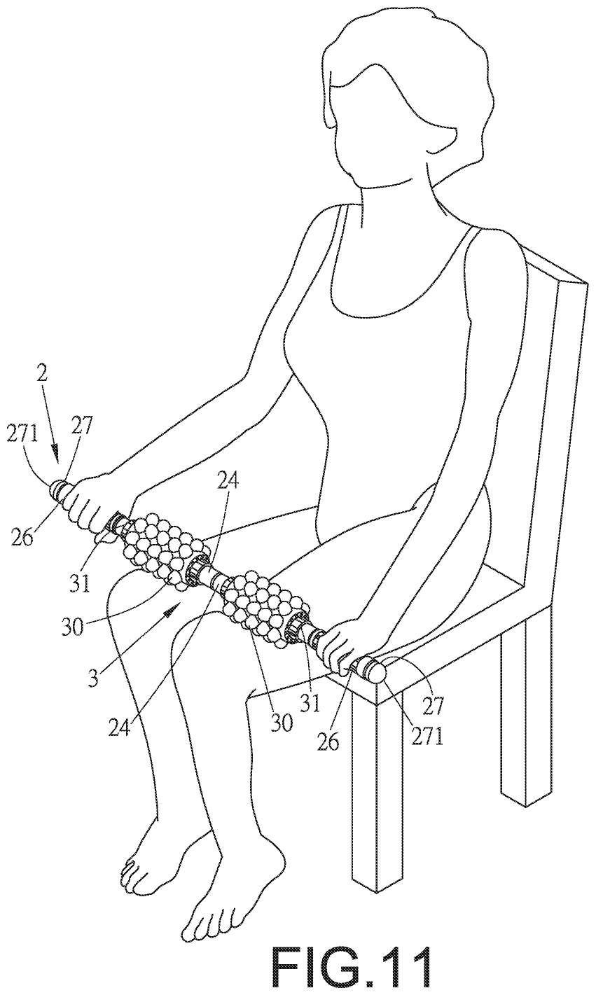

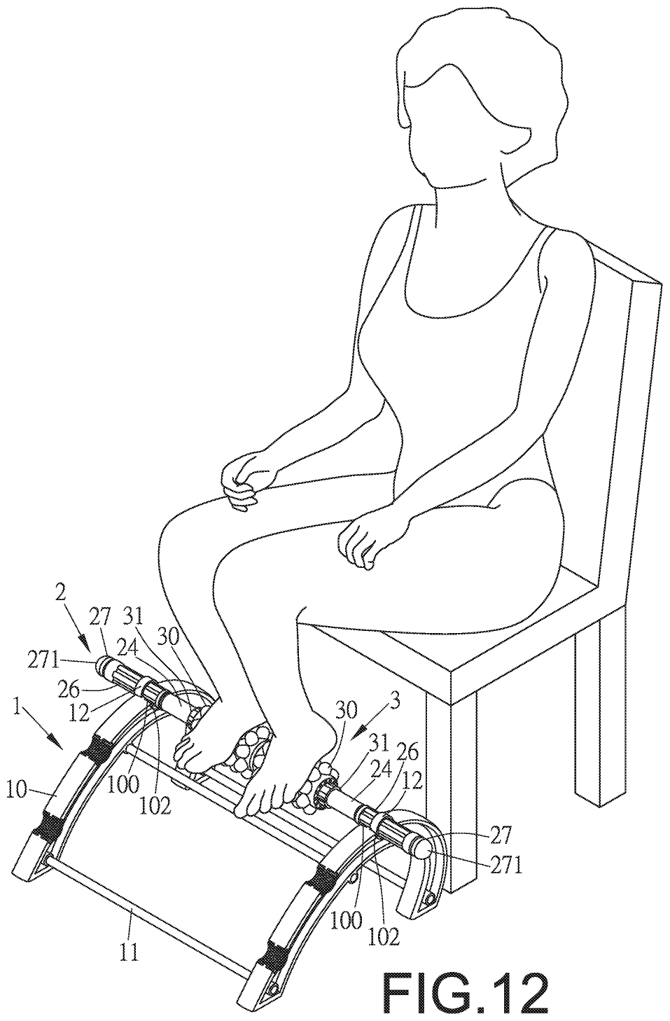

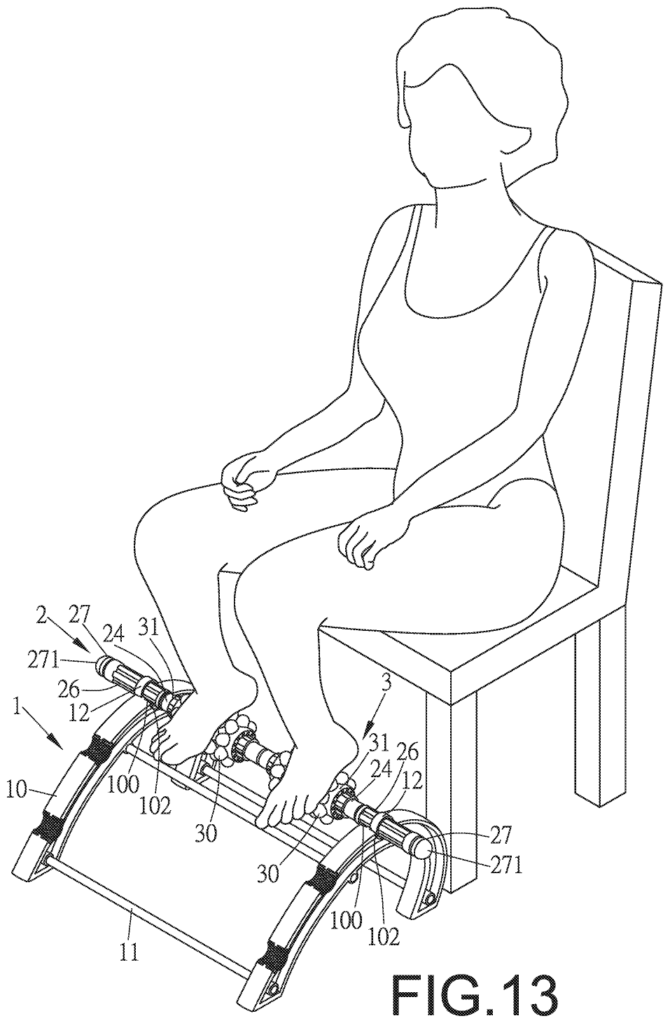

The massage device of the present invention can be operated in various ways. For example, as shown in FIG. 9, a user may hold the two handle tubes 26 of the massage stick 2 and roll one or two massage tubes 24 along a body part. Alternatively, as shown in FIG. 10, the massage stick 2 can be mounted with one or more massage cylinders 30, so that the user may roll the massage cylinders 30 to have the bumps thereon to rub or press a body part. Also, according to a user's need, the distance between the two massage cylinders 30 can be increased, as shown in FIG. 11. Alternatively, as shown in FIG. 12, the massage stick 2 can be installed on the rack 1, so that the user may roll the massage cylinders 30 by her feet to rub or press the sole of her feet. Also, according to a user's need, the distance between the two massage cylinders 30 can be increased, as shown in FIG. 13. While massaging the user's sole, the massage cylinders 30 can be rolled in different direction. For example, one massage cylinder can be rolled forwardly while the other massage cylinder can be rolled backwardly. In addition, each of the plugs connected to the handle tubes 26 can be used to conduct a massage.

While the invention has been described with reference to the preferred embodiment above, it should be recognized that the preferred embodiment is given for the purpose of illustration only and is not intended to limit the scope of the present invention and that various modifications and changes, which will be apparent to those skilled in the relevant art, may be made without departing from the scope of the invention.

What is claimed is:

1. A massage device, comprising:
a massage stick including a rod, two handle tubes, two massage tubes, eight bearings, two first sleeves, two second sleeves, three separation rings, and two nuts, wherein:
the rod has two threaded portions formed at its two ends;
the two handle tubes are fitted around the rod at locations respectively close to the two threaded portions, each handle tube formed with two steps at an inner surface thereof;
the two massage tubes are fitted around the rod between the two handle tubes, each massage tube formed with two steps at an inner surface thereof;
the eight bearings are fitted around the rod such that each of the handle tubes and the massage tubes contains therein two bearings that abut the steps formed therein;
the two first sleeves are fitted around the rod such that each of the handle tubes contains therein one sleeve located between two bearings fitted therein;
the two second sleeves are fitted around the rod such that each of the massage tubes contains therein one sleeve located between two bearings fitted therein;
the three separation rings are fitted around the rod and each located between two adjacent tubes of the handle tubes and the massage tubes, wherein each separation ring abuts two bearings respectively fitted in the adjacent tubes; and
the two nuts are connected with the two threaded portions of the rod respectively, so that the foregoing components are assembled together, and the two handle tubes and the massage tubes are capable of rotating about the rod individually;
whereby a user is allowed to hold the two handle tubes and roll the massage tubes to conduct a massage.

2. The massage device of claim 1, further comprising an accessory kit that includes at least one massage cylinder and a plurality of bushings, the massage cylinder capable of being fitted around one of the massage tubes, each bushing being fitted around the massage tube and inserted between the massage tube and the corresponding massage tube, so that the massage cylinder is fixed onto the massage tube.

3. The massage device of claim 2, wherein each of the bushings defines a groove along a full length thereof and a slit opposite to the groove, and is configured to have an engagement surface tapering off towards one end of the bushing; the massage cylinder is provided with a toothed portion at an inner surface thereof.

4. The massage device of claim 1, further comprising an accessory kit that includes two massage cylinders and a plurality of bushings including a double-taper bushing and two single-taper bushings, wherein the double-taper bushing is configured to have two engagement surfaces respectively tapering off towards two ends of the double-taper bushing, whereas each single-taper bushing is configured to have one engagement surface tapering off towards one end of the single-taper bushing, the massage cylinders capable of being fitted around the two massage tubes respectively, the double-taper bushing capable of being fitted around the separation ring located between the two massage tubes, the engagement surfaces of the double-taper bushing being inserted between the massage cylinders and the massage tubes, each single-taper bushing being fitted around one of the massage tubes and inserted between the massage tube and the corresponding massage cylinder, so that the two massage cylinders are fixed onto the two massage tubes respectively.

5. The massage device of claim 4; wherein each of the double-taper bushing and the single-taper bushings defines a groove along a full length thereof and a slit opposite to the groove; each of the massage cylinders is provided with a toothed portion at an inner surface thereof.

6. The massage device of claim 1, wherein each of the handle tubes is connected with a plug at one end that is distal from the massage tubes.

7. The massage device of claim 1, further comprising a rack that includes two lateral supports each defining a plurality of recesses positioned at different heights, the massage stick being allowed to place across the two lateral supports such that the handle tubes of the massage stick are partly received in two recesses respectively defined at the two lateral supports, and fitted thereon with two retainers each snapped into two grooves of the corresponding recess, so that the massage stick is installed horizontally on the rack.

8. A massage device, comprising:
a massage stick, which includes two handle tubes and at least one massage tube rotatably mounted between the two handle tubes; and
a rack, which includes two lateral supports each defining a plurality of recesses positioned at different heights, wherein the massage stick is allowed to place across the two lateral support such that the handle tubes thereof are partly received in two recesses respectively defined at the two lateral supports and fitted thereon with two retainers each snapped into two grooves of the corresponding recess, so that the massage stick is installed horizontally on the rack.

9. The massage device of claim 8, further comprising an accessory kit that includes at least one massage cylinder and a plurality of bushings each configured to have at least one engagement surface tapering off towards one end thereof, the massage cylinder capable of being fitted around the massage tube, one or more bushings capable of being fitted around the massage tube and inserted between the massage cylinder and the massage tube, so that the massage cylinder is fixed onto the massage tube.

10. The massage device of claim 9, wherein each of the bushings defines a groove along a full length thereof and a slit opposite to the groove; the massage cylinder is provided with a toothed portion at an inner surface thereof.
